(19) United States
(12) Patent Application Publication
(10) Pub. No.: US 2014/0279520 A1
(43) Pub. Date: Sep. 18, 2014

(54) METHOD, SYSTEM AND APPARATUS FOR INTEGRATING TRANSACTION REQUEST FUNCTIONALITY WITH WEB CONTENT

(71) Applicant: Salt and Pepper Design Inc., (US)

(72) Inventors: Blake Robert ARMSTRONG, Toronto (CA); Joe PAONESSA, Mississauga (CA); Kris RYKEN, Toronto (CA)

(21) Appl. No.: 13/837,613

(22) Filed: Mar. 15, 2013

(51) Int. Cl. G06Q 20/40

(52) U.S. Cl. CPC G06Q 20/40
USPC 705/44

(57) ABSTRACT

A system is provided for connecting a client device configured to display content and generate transaction requests, with merchant systems configured to receive and process transaction requests. The system includes an intermediate server and a payment data server. The intermediate server stores a web application including content, and delivers the web application to the client device. The content includes a selectable element for generating a transaction request. The client device detects a selection of the selectable element and sends a transaction request to the intermediate server, which identifies the merchant system associated with the transaction request. The intermediate server determines whether to supplement the transaction request with payment data associated with the client device. When the determination is affirmative, the intermediate server retrieves payment data from the payment data server, other additional data from a database, or both, and adds any retrieved data to the transaction request before forwarding the request to the relevant merchant system.

### FIELD

The specification relates generally to web content, and specifically to a method, system and apparatus for integrating transaction request functionality with web content.

### BACKGROUND

Products and services are provided by a wide variety of commercial entities operating various types of merchant systems. The capabilities of those merchant systems may vary, and thus the amount and timing of data required to order a product or subscribe to a service from such systems may also vary.

In addition, such orders and subscriptions can originate from a variety of client devices (e.g. smart phones, desktop computers, and the like). As a result, the formation and transmission of order or subscription requests, as well as responses to those requests, may make inefficient use of computational resources.

### BRIEF DESCRIPTIONS OF THE DRAWINGS

Embodiments are described with reference to the following figures, in which:

FIG. 1 depicts a communications system, according to a non-limiting embodiment;

FIG. 2 depicts the communications system of FIG. 1, according to a non-limiting embodiment;

FIG. 3 depicts a web application in the system of FIG. 1, according to a non-limiting embodiment;

FIG. 4 depicts a method performed by the client device of FIG. 1, according to a non-limiting embodiment;

FIGS. 5A and 5B depict alternative performances of block 415 of FIG. 4, according to a non-limiting embodiment;

FIG. 6 depicts an additional interface generated by the web application of FIG. 1, according to a non-limiting embodiment;

FIG. 7 depicts a method performed by the intermediate server of FIG. 1, according to a non-limiting embodiment;

FIG. 8 depicts a merchant identifier database stored by the intermediate server of FIG. 1, according to a non-limiting embodiment; and

FIG. 9 depicts user profile and web application databases stored by the intermediate server of FIG. 1, according to a non-limiting embodiment.

### DETAILED DESCRIPTION OF THE EMBODIMENTS

System Overview

FIG. 1 depicts a communications system 100 including various components connected by one or more networks (not shown). The components of system 100 include a client computing device 104 (also referred to as a client device), a plurality of merchant systems 108a, 108b and 108c (generically referred to as a merchant system 108, and collectively referred to as merchant systems 108), an intermediate server 112, and a payment data server 116. Before the components of system 100 and their functions is discussed in detail, a brief overview of those functions will be provided.

Client device 104, which can be operated by an individual consumer (also referred to herein as a user), is configured to download and execute a web application 120. Web application 120 includes content (text, images, video, and the like) that client device 104 can display. The content also includes one or more selectable elements that, when selected, cause client device 104 to generate a transaction request while continuing to display the content.

In general, a transaction request is an instruction to a merchant system 108 to initiate an action downstream of the merchant system 108. For example, a transaction request can be a request to purchase a product, which causes a merchant system 108 to initiate the shipping of the product from a warehouse, and billing of the user. Thus, a transaction request as referred to herein can be contrasted with a request to add a product to a virtual “shopping cart”, as such a request does not result in any downstream action on the part of the merchant system until further instructions (such as an order confirmation instruction) are received.

As will be apparent from the above, merchant systems 108 are configured to receive transaction requests and act on those transaction requests. Merchant systems 108 can be operated by commercial entities that provide products, services or both to consumers such as the user of client device 104. Merchant systems 108 are thus connected to various downstream systems (such as warehouse management and billing systems, not shown) responsible for completing the actions initiated by merchant systems 108. As will be discussed in further detail below, the capabilities of merchant systems 108 vary. For example, some merchant systems 108 are capable of storing payment data (e.g. credit card numbers, in compliance with the Payment Card Industry Data Security Standard, PCI DSS, or any other suitable standard) and other identifying data for users, while other merchant systems 108 are not capable of storing such data for technical reasons, reasons of policy, or both.

Intermediate server 112 is configured to store web application 120 in a web application database and deliver web application 120 (and updates thereto) to client device 104 (see arrow 121), as well as to receive any transaction requests generated by client device 104 (see arrow 122). Intermediate server 112, upon receiving a transaction request, consults a database 124 of merchant identifiers to identify the appropriate merchant system 108 to which to direct the transaction request (see arrow 125; arrows to the other merchant systems 108 not shown for simplicity of illustration). Intermediate server 112 can also modify or supplement the transaction request to compensate for certain limitations in the capabilities of the merchant system 108, such as the above-mentioned inability to store payment data or other data associated with client device 104. Intermediate server 112 can also store a user profile database 128 containing data associated with client device 104 or with the user of client device 104. Database 128 can be used to supplement transaction requests, and to determine the nature of updates to web application 120.

Payment data server 116 stores a database 132 containing payment data (such as credit card numbers and billing addresses) associated with client device 104. The payment data is retrieved by intermediate server 112 (see arrow 133) in order to supplement transaction requests, when necessary. Payment data server 116 is also configured to receive updated payment data from merchant systems 108 (see arrow 134; arrows from the other merchant systems 108 not shown for simplicity of illustration), intermediate server 112, or both (for example, when client device 104 sends updated payment data to intermediate server 112 for delivery to a merchant system 108).

Therefore, system 100 enables client device 104 to issue transaction requests destined for any of merchant systems 108 with minimal interruptions to content display, even if the relevant merchant system 108 lacks various data storage capabilities required to fulfill the requested transaction.

Example Hardware Implementation

Turning to FIG. 2, an example implementation of system 100 is shown. The implementation shown in FIG. 2 is provided for illustrative purposes only, and those skilled in the art will appreciate that other implementations are also suitable.

Client device 104 can be a tablet computer, a smart phone, a desktop computer, or any other suitable computing device. Client device 104 includes a processor 204 interconnected with a computer readable storage medium such as a memory 208. Memory 208 can be any suitable combination of volatile (e.g. Random Access Memory (“RAM”)) and non-volatile (e.g. read only memory (“ROM”), Electrically Erasable Programmable Read Only Memory (“EEPROM”), flash memory, magnetic computer storage device, or optical disc) memory. In the present example, memory 208 includes both a volatile memory and a non-volatile memory. Other types of non-transitory computer readable storage medium are also contemplated, such as compact discs (CD-ROM, CD-RW) and digital video discs (DVD).

Client device 104 also includes one or more input devices interconnected with processor 204, illustrated generically as an input device 212. Such input devices can include any one of, or any suitable combination of, a keypad, a keyboard, a mouse, a microphone, a touch screen, other sensors (e.g. light or temperature sensors) and the like. Input device 212 receives input, for example in the form of taps or swipe gestures on a touch screen, and transmits input data to processor 204 representing the taps or swipe gestures. Other inputs are also contemplated, such as proximity of a user to input device 212 (sensed by a heat or light sensor), for example.

Client device 104 also includes one or more output devices interconnected with processor 204, illustrated generically as an output device 216. Output device 216 can include any one of, or any combination of, a display (e.g. a Liquid Crystal Display (LCD), a plasma display, an Organic Light Emitting Diode (OLED) display, a Cathode Ray Tube (CRT) display, and the like), one or more speakers, and the like. It is contemplated that when input device 212 includes a touch screen and output device 216 includes a display, the touch screen and the display can be integrated with each other.

Client device 104 also includes a network interface controller (NIC) 220 interconnected with processor 204. NIC 220 allows client device 104 to communicate with other devices via a link with a network 224, or via a direct, local connection (such as a Universal Serial Bus (USB) or Bluetooth™ connection, not shown). Network 224 can include any suitable combination of wired and/or wireless networks, including but not limited to a Wide Area Network (WAN) such as the Internet, a Local Area Network (LAN), cell phone networks, WiFi networks, WiMax networks and the like.

NIC 220 is therefore selected for compatibility with network 224, as well as with local links as desired. In the present example, the link between NIC 220 and network 224 is a wireless link, such as a WiFi link. NIC 220 thus includes the necessary hardware for communicating over such a link, such as one or more transmitter/receiver assemblies, or radios, and associated circuitry. In other examples, the link between computing device 104 and network 224 can be wired.

Client device 104 stores, in memory 208, a plurality of computer readable instructions executable by processor 204. These instructions include an operating system and a variety of applications (not shown), such as a web browser application. The instructions also include, as shown in FIG. 2, web application 120. When client device 104 is described herein as performing various functions, it will be understood that those functions are performed by processor 204 during the execution of web application 120 in conjunction with other applications, such as the operating system and the browser.

Each of merchant systems 108, intermediate server 112, and payment data server 116 also include NICs, processors and memories that are substantially as described above in connection with computing device 104 (though they need not be the same type of processor, NIC or memory, for example). Thus, merchant systems 108a, 108b and 108c include processors 228a, 228b, 228c respectively, memories 232a, 232b and 232c respectively, and NICs 236a, 236b and 236c respectively. Memories 232 of merchant systems 108 store databases 240a, 240b and 240c, which can include various product information and, depending on the capabilities of merchant systems 108, payment data for users.

Similarly, intermediate server 112 includes a processor 244, a memory 248 and a NIC 252, while payment data server includes a processor 256, a memory 260, and a NIC 264.

Client Device and Web Application

Web application 120, and its execution by client device 104, will now be described in further detail. Referring to FIG. 3, display 216 of client device 104 is shown. Client device 104 is assumed to have previously received web application 120 from intermediate server 112 (for example, by sending an HTTP request to intermediate server 112)—the delivery of web application 120 to client device 104 will be discussed in greater detail below, in connection with the operation of intermediate server 112. Having received web application 120, client device 104 is configured to execute web application 120. In the present example, web application 120 is executed within a web browser application on client device 104.

Web application 120 includes content in the form of any suitable combination of text, images, video files, audio files and the like. The organization of the content included in web application 120 is not particularly limited, however in the present example the content is arranged in tiles, as shown in FIG. 3. In particular, FIG. 3 shows a tile 300 of content contained within web application 120, rendered on display 216. Tile 300 includes a block of text 304, and an image 308. Image 308, in the present example, is an image of a product, such as a brand of breakfast cereal.

Web application 120 also includes additional tiles 312 and 316. Client device 104 is configured, in response to input such as a swipe gesture detected at input device 212, to replace the tile currently presented on display 216 (in the present example, tile 300), with another tile based on the direction of the gesture. For example, tile 300 can be replaced on display 216 with tile 312 in response to a gesture travelling from right to left, simulating the turning of a page. Tile 312 can then be replaced on display 216 with tile 316 in response to a gesture travelling from bottom to top. The above gesture-based inputs can be repeated in the opposite order to return to tile 300. As mentioned earlier, gesture-based inputs can also be substituted with a variety of other inputs, or used in conjunction with other inputs.

In addition, tile 300 includes a scroll bar 320 which is selectable for scrolling between the tiles 300, 312 and 316. In some examples, when scroll bar 320 is selected a preview (not shown) of the tile being scrolled to may be presented. Tile 300 also includes a selectable link 324 to a table of contents tile 328. Tile 328 includes thumbnails of each other tile in web application 120. It is contemplated that tiles 312 and 316 also include scroll bar 320 and link 324.

Tile 300 also includes a selectable element 332 associated with image 308. Element 332 is selectable for causing client device 104 to generate a transaction request. In the present example, element 332 is selectable for generating a request to purchase the above-mentioned breakfast cereal. In other examples, any of a wide variety of transaction requests can be initiated by element 332. Other examples of transaction requests include requests to subscribe to a service, newsletter or other publication supplied by a merchant system 108; and requests to schedule a one-time service, such as a test-drive of an automobile or a hotel stay. In general, as mentioned earlier, transaction requests cause merchant systems 108 to initiate some form of downstream action.

Although only one selectable element 332 is shown, it is contemplated that any of tiles 300, 312 and 316 can include any number of selectable elements. Each selectable element can cause client device 104 to generate a different transaction request.

Client device 104 is configured, via the execution of web application 120, to take certain actions in response to the selection of element 332, as will be discussed below in connection with FIG. 4. FIG. 4 depicts a method 400 performed on client device 104.

Beginning at block 405, client device 104 is configured to present the content contained in web application 120 on display 216, as described above. The performance of block 405 thus includes transitioning between tiles using scroll bar 320, swipe gestures, and any other suitable inputs. It will be assumed that tile 300 is currently being displayed during the performance of method 400

At block 410, client device 104 determines whether element 332 has been selected (for example, by detecting a tap, click, or other input at the location on display 216 where element 332 is presented). If the determination is negative, the presentation of content continues as discussed above at block 405. If, however, the determination is affirmative, indicating that element 332 has been selected, the performance of method 400 proceeds to block 415.

At block 415, client device 104 can be configured to determine whether or not to dynamically scale the content currently presented on display 216 to accommodate a transaction interface. In general, web application 120 can include instructions indicating whether or not content presented on display 216 is to be scaled to accommodate a transaction interface. For example, each tile that includes one or more selectable elements such as element 332 can include an indication of whether or not the remaining content of the tile should be scaled when the selectable element is selected. In the present example, tiles in web application 120 that include videos also include instructions to scale the videos when element 332 is selected.

If the determination at block 415 is affirmative (that is, if web application 120 includes an instruction to scale the content presented at block 405), then client device 104 updates the content presented on display 216 before proceeding to block 425. If the determination at block 415 is negative (no scaling required), then client device 104 proceeds directly to block 425. At block 425, a transaction interface is presented on display 216 over the content, as will be discussed in connection with FIGS. 5A and 5B.

FIGS. 5A and 5B depict examples of the results of performing blocks 420 and 425. In particular, FIG. 5A depicts a performance of method 400 in which the determination at block 415 was negative. As seen in FIG. 5A, a transaction interface 500 is shown overlaid on tile 300, and the content of tile 300 has not been scaled to accommodate interface 500. In FIG. 5B, however, the determination at block 415 was affirmative, and the content of tile 300 has been scaled down such that there is little or no overlap between the content and interface 500.

As seen in both FIGS. 5A and 5B, transaction interface 500 can include image 308 or a related image, to indicate that interface 500 is associated with image 308 as presented in tile 300. In addition, interface 500 can include additional content (that is, content not shown in the currently displayed tile) relating to image 308, such as a description of the product or service represented by image 308. In addition, interface 500 includes one or more fields (such as the “quantity” field shown in FIGS. 5A and 5B) for receiving data defining a transaction request, as well as a selectable option to send the transaction request (such as the “buy” button shown in FIGS. 5A and 5B). The nature of the fields and the selectable option are not particularly limited. In general, interface 500 can any suitable combination of fields required to generate the transaction request. Thus, in another example, a transaction interface for signing up for an automobile test-drive can include fields for entering a desired time and date, a desired location and the like.

Referring again to FIG. 4, following generation of the transaction interface and receipt of input data at block 425, at block 430 the transaction request is generated and sent to intermediate server 112 at block 430. The processing of the transaction request at intermediate server 112 will be discussed in greater detail below. From the perspective of client device 104, following the transmission of the request, client device 104 receives a notification from intermediate server 112 that the transaction request has been successfully processed (that is, the requested purchase, subscription or the like has been completed). Client device 104 is configured to then return to block 405 for continued content display. The return to block 405 can include automatically dismissing interface 500, or updating interface 500 with an indication of success and waiting for input to dismiss interface 500.

Thus, web application 120 provides for the display of content, and for the generation of a transaction request related to the displayed content, while minimizing interruptions to content presentation. As will be apparent from the above, web application 120 is not redirected from the currently displayed tile in order to generate the transaction request.

Additional features of web application 120 are also contemplated. For example, web application 120 can be configured to automatically send a request for updated content to intermediate server 112 at predetermined time intervals, or when a specific tile is displayed (for example, a “cover” tile representing the first or main portion of web application). Web application 120

Further, web application 120 can be configured to transmit periodic messages to intermediate server 112 containing usage statistics. Examples of such statistics include the length of time that each tile (or any other portion, if web application 120 is not tiled) of content has been displayed for, the location of client device 104, the frequency and nature of swipe gestures or other inputs detected in connection with web application 120, and the like.

In addition, it is contemplated that one or more portions (e.g. tiles) of web application 120 can include a selectable option for generating a login interface. An example login interface 600 is shown in FIG. 6, overlaid on tile 300 (although it will be understood that login interface 600 can be overlaid on any tile or other portion of content). Login interface includes fields for entering a user identifier and password, and a “submit” or other selectable element for submitting the data entered in the fields to intermediate server 112 for authentication. Interface 600 also includes an additional selectable element for creating an account (for example, if the user of client device 104 does not have login credentials). Selection of the “create account” element causes client device 104 to generate a further interface including fields for creating a user identifier and password, as well as optional fields for entering further identifying data (address, telephone number, and the like), payment data and the like. It is contemplated that web application 120 can also generate other interfaces, such as an interface to add payment or identifying data to an existing account, or to update such data.

As will be discussed below in connection with intermediate server 112, client device 104 can be configured to present login interface 600 either in response to selection of a login element in web application 120, or in response to a login request from intermediate server 112.

Intermediate Server

The operation of intermediate server 112 will now be described in further detail. In broad, terms, the functionality implemented by intermediate server 112 includes content selection and delivery, and transaction request processing. Transaction request processing will be discussed first, referring to FIG. 7.

FIG. 7 depicts a method 700 of processing a transaction request at intermediate server 112. At block 705, transaction server receives a transaction request from client device 104 via network 224. For example, the transaction request can be the request to purchase the breakfast cereal discussed above.

Because the transaction request must be directed to the correct one of merchant systems 108 (and, as noted earlier, web application 120 may include selectable elements for generating transaction requests associated with a variety of merchant systems), intermediate server 112 is configured, at block 710, to identify which merchant system 108 is associated with the transaction request.

The identification of the associated merchant system 108 is not particularly limited. For example, in some embodiments the transaction request itself, as received from client device 104, includes a merchant system identifier. In other embodiments, the correct merchant system must be identified by consulting the transaction request and database 124. An example of database 124 is shown in FIG. 8—although database 124 is shown in a tabular format, it is contemplated that any suitable database structure can be employed.

Database 124 includes a record 800a, 800b, 800c for each merchant system 108. Each record 800 includes a merchant identifier field 804 containing a name or other identifier of the merchant system 108. Each record 800 also includes a network address field 808 containing an IP address, domain or the like, sufficient for intermediate server 112 to address messages to merchant systems 108. Each record 800 also includes a product identifier field containing identifiers of the products and services associated with each merchant. The product identifiers can take a variety of formats, including, for example, the UPC code shown in record 800c. In addition, each record 800 includes a field 812 indicating whether or not the merchant system is capable of storing user data, such as payment and contact data.

The identification of the merchant system 108 associated with the transaction request received at block 705 can therefore include comparing the transaction request to database 124 to determine whether the data in the transaction request matches any of records 800. In the present example, it will be assumed that the transaction request received from client device 104 includes the product identifier “Cereal 308”, corresponding to the breakfast cereal identified by image 308, mentioned earlier. Therefore, at block 710, intermediate server 112 detects a match between the transaction request and record 800a, indicating that merchant 108a is associated with the transaction request.

At block 715, intermediate server 112 is configured to determine whether or not the relevant merchant system is capable of storing payment data or other data identifying client device 104 or the user of client device 104. As mentioned earlier, some merchant systems 108 are capable of storing credit card numbers and other data, while other merchant systems do not have such capabilities and must be provided with such data for every transaction. As will now be apparent to those skilled in the art, merchant systems that are capable of storing user data need only be provided with an identifier of the user or client device 104 (e.g. an account number or name) in a transaction request, following which they can retrieve payment details and other data from databases 240. Merchant systems without that capability require user data to be provided to them by intermediate server 112 in order to fulfill a transaction.

The determination at block 715 is performed by inspecting the data storage field 812 for the record 800 of the merchant system identified at block 710 (in this case, record 800a). As seen in FIG. 8, field 812 of record 800a contains an indication (“no”) that merchant system 108a does not store user data. The determination at block 715 is therefore negative. On the other hand, it can be seen from FIG. 8 that merchant systems 108b and 108c do store user data. The nature of the indicator in field 812 is not particularly limited—bit flags, numerical values, and the like can be used instead of “yes” and “no” values. Further, field 812 can contain more fine-grained indicators. For example, field 812 can indicate whether a merchant system 108 is capable of storing payment data, and also indicate separately whether the same merchant system 108 is capable of storing user contact data.

Returning to FIG. 7, following the negative determination at block 715, intermediate server 112 is configured to retrieve any data associated with client device 104 or the user of client device 104 that will be necessary to enable merchant system 108a to act on the transaction request. The nature of the data retrieved at block 720 depends on the nature of the transaction request. Therefore, intermediate server 112 can also store data defining types of transaction requests and the categories of data required to complete such requests.

In the present example, because the transaction request is a request to purchase a breakfast cereal, payment data is required. Thus, intermediate server 112 is configured to request payment data from payment data server 116, which stores payment data for a variety of user accounts associated with a variety of client devices. Therefore, intermediate server 112 can be configured, at any point prior to block 720, to confirm the identity of client device 104. Various ways of confirming the identity of client device 104 are contemplated. For example, intermediate server 112 can maintain user accounts associated with client devices in database 128. Thus, intermediate server 112 can be configured to check whether client device 104 has provided authentication credentials (such as a login and password) corresponding to an account in database 128. Such credentials can be required for every transaction request, or within a certain time period before the transaction request. If client device 104 has not provided authentication credentials recently enough, intermediate server 112 can instruct client device 104 to generate login interface 600 as discussed above, and return login credentials to server 112.

Having confirmed the identity of client device 104, intermediate server 112 can proceed with the retrieval of payment data from payment data server 116. The retrieval of payment data includes transmitting a request to payment data server 116, including an identifier of the user or of client device 104. Payment data server 116, which will be described in greater detail below, responds to the request by either providing the requested data, or indicating that the requested data does not exist at payment data server 116. In the event that the payment data cannot be retrieved from payment data server 116, intermediate server 112 can instruct client device 104 to generate an interface within web application 120 for entering payment data.

The retrieval of user data at block 720 can also include retrieving data from user profile database 128 within intermediate server 112. Database 128 can include various data corresponding to a user or the client device associated with the user, such as a name, email addresses, physical addresses, telephone numbers, age, gender and the like. Thus, if the merchant system 108 identified at block 710 is not capable of storing user information that is not directly related to payment, but that is required to complete the transaction request, database 128 may be accessed to retrieve user data, instead of or in addition to payment data server 116.

Once the necessary user data has been retrieved, intermediate server 112 is configured to modify the transaction request at block 725. The modifications to the transaction request received from client device 104 include adding the data retrieved at block 720, and converting the transaction request to a format compatible with merchant system 108a. For example, intermediate server 112 can be configured to convert the transaction request from client device 104 into an Application Programming Interface (API) message according to an API published by merchant system 108a. Intermediate server 112 can maintain indications of which APIs to use for which merchants in database 124.

Once the modified transaction request has been sent, intermediate server 112 waits for a response confirming that the transaction request has been successfully processed at merchant system 108a, and forwards the response to client device 104 (see block 435, discussed above).

Intermediate server 112 therefore enables web application 120 to contain selectable elements (such as element 332) associated with a variety of merchant systems 108, without being required to contact those merchant systems 108 separately. In addition, server 112 enables web application 120 to make transaction requests in a consistent manner, regardless of the capabilities of the various merchant systems 108.

Turning now to FIG. 9, the content delivery functions of intermediate server 112 will be discussed. These functions can be implemented in intermediate server 112 alongside the processing of transaction requests. In general, intermediate server 112 is configured to select content for delivery to client device both upon an initial request from client device, and upon various later events, such as the passage of a predefined time period, the receipt of an update request from client device 104, and the like.

FIG. 9 depicts an example of user profile database 128 stored by intermediate server 112. Database 128 includes a record 900 for each user registered with intermediate server 112. Each record 900 includes a user identifier 904 (also referred to as an account name), a password 918, and a list of the client devices known to be associated with the user identifier 904. Field 908 can be updated to include a new device identifier whenever intermediate server 112 receives messages containing user ID 904 from a client device not already listed in field 908.

Database 128 also includes identifying data such as one or more email addresses 912, a telephone numbers 916, physical addresses (not shown) and the like. In addition, database 128 can contain usage tracking data received from client device 104. Such data, although not shown in FIG. 9, can include which web applications have been most frequently requested by user ID 904, which specific portions of content within particular web applications have been accessed most frequently, which selectable elements 332 have been used to initiate transaction requests at client device 104, and so on. Other examples of usage data include the physical location of client device 104, metrics describing inputs received at client device 104 (e.g. the length and speed of swipe gestures, or parameters describing other inputs), and the like.

Intermediate server 112 can be configured to update the above-mentioned usage data in response to messages received from client device 104. As noted earlier, client device 104 can be configured, via execution of web application 120, to send usage statistics to intermediate server 112. In the event that usage statistics are received at intermediate server 112 from a client device that is associated with more than one account in database 128, intermediate server can attempt to determine which account to store the usage data with. For example, the determination can be based on the current physical location of the device (perhaps one account is frequently in use at a particular location), the nature of swipe gestures (which may vary in character from user to user), and the like.

Still referring to FIG. 9, a web application database 920 can be stored in memory 248 of intermediate server 112. Database 920 contains a plurality of web applications, including web application 120. Web applications can be provided to intermediate server 112 by merchant systems 108, publishers and the like. Although web application 120 is shown as being stored in a record 924 of database 920, a wide variety of data structures are possible for storing web applications, additional content, and associated data.

Each record 924 of database 920 includes an identifier 928 of the web application, and a content repository 932 for the application. Content repository can include primary content 936, such as the text block 304 shown in FIG. 3, and additional content 940, such as image 308 and selectable element 332 (that is, content related to products and services) shown in FIG. 3. When client device 104 requests web application 120, intermediate server can be configured to retrieve at least a portion of primary content 936, and at least a portion of additional content 940, combine the retrieved content portions, and transmit them to client device 104.

The selection of content portions can be based on user preferences and usage data from database 128. For example, if client device 104 has frequently reported spending little time on certain types of content (such as articles discussing breakfast nutrition), intermediate server 112 may exclude such content, as well as any additional content associated with breakfast-related products and services, from web application 120. Certain content portions can also be selected or excluded based on the location of client device 104, the transaction request history of client device 104, and the like. For example, if transaction request was recently received from client device 104 to purchase a dress shirt, an image of a tie may be selected from additional content 940 instead of image 308 of breakfast cereal. It is contemplated that the above selection process can be carried out not only upon initial delivery of web application 120 to client device 104, but also upon delivery of updates for web application 120 to client device 104.

In other embodiments, the selection and exclusion of content portions can be omitted, and web application can be substantially static (that is, the same content can be delivered whenever web application 120 is requested).

Database 920 also includes parameters, such as a flag indicating whether or not usage data is to be added to database 128 in connection with web application 120. If set to “no”, intermediate server can be configured to disable any instructions in web application 120 for causing client device 104 to transmit usage statistics. Other parameters (not shown) include whether or not to make use of dynamic content selection as discussed above.

Payment Data Server

Payment data server 116 can be configured to store, in database 132, payment data including credit card numbers or bank account identifiers associated with the account identifiers from database 128. In addition, payment data server 116 is configured to receive updated payment data from merchant systems 108 and intermediate server 112. For example, merchant systems 108 that are capable of storing payment data can be configured to transmit updated payment details when such updated payment details are received from client device 104, via intermediate server 112 (for example, client device can provide a payment detail interface used to enter new or updated payment data).

Merchant systems 108 that are not capable of storing payment data can nevertheless be configured to transmit payment data to payment data server 116 upon successful completion of a transaction (that is, before payment data used in the transaction is deleted by the merchant system 108).

Alternatively, for merchant systems 108 that are not capable of storing payment data, intermediate server 112 can be configured to send payment data received from client device 104 to payment data server 116, when such data is not already stored in payment data 116. For example, intermediate server can send the payment data at substantially the same time as the transaction request is forward to a merchant system 108 at block 725.

Those skilled in the art will now recognize that variations can be made to the systems and methods herein. For example, although system 100 has been described as containing multiple merchant systems 108, in other embodiments only one merchant system 108 can be provided.

As another example, client device 104 can also be configured to bookmark or un-bookmark tiles or other portions of web application 120, and to transmit indications of such bookmarking to intermediate server 112. As a result, intermediate server 112 can be configured to always include bookmarked content or to exclude un-bookmarked content from web application 120 in subsequent updates.

Persons skilled in the art will appreciate that there are yet more alternative implementations and modifications possible for implementing the embodiments, and that the above implementations and examples are only illustrations of one or more embodiments. The scope, therefore, is only to be limited by the claims appended hereto.

We claim:

1. A system for connecting a client device configured to display content and generate transaction requests, with merchant systems configured to receive and process transaction requests, the system comprising:
an intermediate server connected with the client device and the merchant systems, the intermediate server storing a web application containing the content, the content including an element selectable for causing the client device to generate a transaction request associated with one of the merchant systems; and,
a payment data server connected with the intermediate server and the merchant systems, the payment data server storing payment data associated with the client device;
the intermediate server configured to deliver the web application to the client device for display at the client device;
the client device configured to execute the web application and, in response to a selection of the selectable element, to generate and send the transaction request to the intermediate server;
the intermediate server configured to receive the transaction request, to identify the merchant system associated with the transaction request, and to forward the transaction request to the identified merchant system;
the intermediate server further configured to determine whether to supplement the transaction request with payment data associated with the client device prior to forwarding the transaction request, and if the determination is affirmative, to retrieve the payment data from the payment data server and add the payment data to the transaction request.

2. The system of claim 1, the intermediate server further configured to determine whether the client device is authenticated, and when the determination is negative, to send an instruction to the client device to provide authentication data.

3. The system of claim 1, the intermediate server further configured, when retrieval of payment data fails, to send an instruction to the client device to provide payment data.

4. The system of claim 2, the web application further comprising a login interface, the client device configured to generate the login interface in response to the instruction.

5. The system of claim 1, wherein forwarding the transaction request includes translating the transaction request into a format compatible with the associated merchant system.

6. The system of claim 1, the client device configured, prior to generating the transaction request, to present a transaction interface overlaid on the currently displayed content.

7. The system of claim 6, the client device further configured to receive a notification from the intermediate server that the transaction request was successfully processed by the associated merchant system, and to cease presenting the transaction interface.

8. The system of claim 1, the intermediate server further configured to deliver updates to the content to the client device.

9. The system of claim 8 wherein the updates are automatically selected by the intermediate server based on user profile data associated with the client device.

10. The system of claim 9 wherein the user profile data includes a history of transaction requests generated by the client device.

11. The system of claim 9 wherein the user profile data further includes a current location of the client device.

12. The system of claim 9 wherein the user profile data further includes an indication of frequently accessed content from the web application at the client device.

13. The system of claim 9, the client device further configured to transmit at least a portion of the user profile data to the intermediate server.

14. The system of claim 1, the transaction request including an identifier of a product or service corresponding to a portion of the content.

15. The system of claim 1, the transaction request for causing the merchant system to initiate an action.

16. The system of claim 15 wherein the action includes the shipping of a product and the billing of an account.

17. The system of claim 15 wherein the action includes the creation of a subscription to a service.

18. The system of claim 1, the client device configured, upon selection of the selectable element, to display a transaction interface prior to generating the transaction request.

19. The system of claim 18, the client device configured to scale the displayed content so as to display the content and the transaction interface simultaneously.

20. An intermediate server, comprising:
a memory;
a network interface for communicating with a client device, a plurality of merchant systems, and a payment data server; and
a processor interconnected with the memory and the network interface, the processor configured to:
deliver a web application to the client device, the web application including content for display at the client device, the content including an element selectable for causing the client device to generate a transaction request;
receive a transaction request from the client device;
identify one of the merchant systems as being associated with the transaction request;
determine whether the identified merchant system stores payment data associated with the client device, and when the determination is negative, retrieve the payment data from the payment data server for addition to the transaction request; and
forward the transaction request to the identified merchant system.
